(19) United States
(12) Patent Application Publication
(10) Pub. No.: US 2026/0120355 A1
(43) Pub. Date: Apr. 30, 2026

(54) METHOD AND DEVICE FOR STRUCTURING DISASTER INFORMATION BASED ON SYMBOLIZATION OF DISASTER DAMAGE PROGRESSION PATTERN

(71) Applicant: NATIONAL DISASTER MANAGEMENT RESEARCH INSTITUTE, Ulsan (KR)

(72) Inventors: Dongjin CHOI, Ulsan (KR); Kyungmin SEO, Ulsan (KR); Jeahak JEONG, Daegu (KR)

(21) Appl. No.: 18/989,008

(22) Filed: Dec. 20, 2024

(30) Foreign Application Priority Data
Oct. 24, 2024 (KR) 10-2024-0146608

(51) Int. Cl. G06T 11/60; G06F 16/28

(52) U.S. Cl. CPC G06T 11/60; G06F 16/285

(57) ABSTRACT

The disclosure relates to a technology for visually representing a disaster occurrence and a scenario of a damage situation caused by the disaster occurrence based on a time-series causal relationship, and a method for structuring disaster information by a disaster information management device includes receiving disaster damage history information and generating the disaster damage scenario by visualizing a situation and flow of damage caused by a disaster in the form of a scenario using a symbolization model from the received disaster damage history information, in which the symbolization model is represented by components classified into hazard, exposure, and impact.

### CROSS REFERENCE TO RELATED APPLICATION

This application claims priority from Republic of Korea Patent Application No. 10-2024-0146608, filed on Oct. 24, 2024, which is hereby incorporated by reference in its entirety.

### BACKGROUND

### Field

The present disclosure relates to a technology for visually representing a disaster occurrence and a scenario of a damage situation caused by the disaster occurrence based on a time-series causal relationship, and more particularly, to a method and device for structuring disaster information based on symbolization of a disaster damage progression pattern.

### Description of Related Art

Recently, disasters and safety accidents occurring in our society, such as the Itaewon stampede, are illustrating a tendency to become complex and large-scale with new disaster patterns that we have never experienced in the past. The development and distribution of new technologies along with the rapidly changing society and environment are making extreme situations in the social environment called disasters more complex and difficult to predict, increasing uncertainty. For example, behind the innovation of cutting-edge technologies such as autonomous driving and electric vehicles, there is a phenomenon in which disasters spread to extreme situations that are difficult to control with the current disaster management response measures due to misalignment with the current social environment. In particular, in the domestic housing culture centered on apartments, it has been observed that large-scale damage is occurring due to electric vehicle fires parked in underground parking lots.

Meanwhile, it is pointed out that the existing experience-centered disaster management system may have problems with new types of disasters. In a situation where it is difficult to predict the nature and intensity of disasters, there are limits to managing potential (new) disasters that are complex and highly uncertain based on disaster prediction and response based only on past experiences. Furthermore, there is also a criticism that frequent changes in government agency positions and personnel transfers ultimately result in a lack of continuous accumulation of disaster safety management work experience.

Despite the recurrence of major accidents, there is criticism that there is a lack of a system that focuses on response and post-management to identify the fundamental characteristics of disasters and accidents and prevent damage. In other words, continuous risk management centered on prediction and prevention is required to proactively manage by discovering and analyzing the changing disaster environment and new hazard in advance. In order to discover new risks that may occur in the future, it is important to accurately understand the detailed situation in which disaster damage progresses and to identify uncertainties.

Disaster safety management is a part of the work of predicting risks that may occur in the future and preventing immediate risks based on the experience of past disasters and the knowledge of experts. In order to preemptively prepare for and respond to new disasters that have not been experienced in the past, technology and tools capable of systematically and specifically reproducing the complex possibility of disasters that may occur due to potential hazard in our society and a chain flow (process) are necessary.

The prior art documents presented below present techniques for generating disaster-related scenarios and predicting disaster spread through the scenarios, but there is a lack of consideration on how to define or express the disaster itself so that disasters can be understood more effectively and various people in charge can respond appropriately to disaster situations. Before constructing the scenario for disaster or predicting a disaster, a process of analyzing the disaster more closely is required. From this perspective, it is necessary to present a new methodology for collecting various information on disasters and generating structured information on the disaster from the collected information.

### PRIOR ART DOCUMENT

Korean Patent No. 10-2191763 entitled “Scenario based Disaster Prediction System and the Method”

### SUMMARY

The technical problems to be solved by embodiments of the present disclosure are to resolve the problem that conventional disaster-related documents, such as disaster damage white papers, disaster damage reports, and casebooks, record the history and experience of disasters but make it difficult to reuse the knowledge, resolve the inconvenience that the description of the damage progression pattern of the disaster may be expressed in different ways depending on the disaster manager due to the lack of a unified method, and overcome the weakness that makes it difficult to establish a response strategy based on the disaster damage scenario.

In order to solve the above technical problem, according to one embodiment of the present disclosure, there is provided a method for structuring disaster information by a disaster information management device including at least one processor, the method including: receiving disaster damage history information by the disaster information management device; and generating a disaster damage scenario by visualizing a situation and flow of damage caused by a disaster in the form of a scenario using a symbolization model from the received disaster damage history information by the disaster information management device, in which the symbolization model represents a chain damage flow of the disaster with a unique symbol according to a disaster damage progression pattern, and includes components classified into hazard which indicates a natural phenomenon or human-induced physical event or physical influence that causes the damage, exposure which indicates that an entity such as a human, living organism, ecosystem, building, or facility is into contact with the hazard, and impact which indicates physical, social, system, and functional effects or actions caused by the exposure.

In the method for structuring disaster information according to one embodiment, in the symbolization model, the hazard, the exposure, and the impact may be set in advance as unique symbols according to a type of a detailed component, and items that can occur may be linked and configured according to a time-series order or causal relationship of each component, and the unique symbol may be set so that the unique symbol is visually identified through at least one of a shape or color of a figure or a combination thereof.

In the method for structuring disaster information according to one embodiment, in the symbolization model, the hazard may have, as a detailed component, a cause of damage set according to at least one of the conditions of a type, scale, and region of the disaster, and in the generating of the disaster damage scenario, when a plurality of causes causing the damage have a sequential structure, the order of the causes may be visually displayed differently.

In the method for structuring disaster information according to one embodiment, in the symbolization model, the exposure may have, as a detailed component, a damaged region indicating geographical information where damage occurs and a damage object indicating an object where damage occurs in a region in into contact with a hazard, and in the generating of the disaster damage scenario, a geographical type or administrative district of the damaged region may be set, and according to the setting of the damaged region, a physical natural object or artificial object within the region may be set as the damage object.

In the method for structuring disaster information according to one embodiment, in the symbolization model, the impact may have, as a detailed component, a damage result indicating a change in a state of a damage object due to the cause of the damage, and human losses and property damage occurring in the damage object according to the damage result, and in the generating of the disaster damage scenario, a state in which a target's intended function is completely lost or a physical form or properties of the target are changed may be set as the damage result, and the type of damage that occurs according to the setting of the damage result may be set according to the classification criteria.

In the method for structuring disaster information according to one embodiment, the method may further include pre-storing additional information organized based on cases from the disaster damage history information for each component for the symbolization model in a database, in which the additional information may be stored in a manner that links possible occurrence items according to a time-series order or causal relationship of each of the detailed components of the hazard, the exposure, and the impact that constitutes the symbolization model.

In the method for structuring disaster information according to one embodiment, the method may further include generating a response strategy for the generated disaster damage scenario, in which in the response strategy, a disaster damage situation may be derived according to the disaster damage scenario, a response agency for each detailed item may be set in response to each derived disaster damage situation, and a response task may be assigned according to passage of time to the set response agency.

Furthermore, the following provides a computer-readable recording medium having recorded thereon a program for executing the above-described method for structuring disaster information on a computer.

In order to solve the above technical problem, according to one embodiment of the present disclosure, there is provided a disaster information management device including: a memory that stores a program for receiving disaster damage history information and structuring the disaster information; and a processor that executes the program stored in the memory, wherein the program includes a command for generating a disaster damage scenario by visualizing a situation and flow of damage caused by the disaster in the form of a scenario using a symbolization model from the received disaster damage history information, and the symbolization model represents a chain damage flow of the disaster with a unique symbol according to a disaster damage progression pattern, and includes components classified into hazard which indicates a natural phenomenon or human-induced physical event or physical influence that causes the damage, exposure which indicates that an entity such as a human, living organism, ecosystem, building, or facility is into contact with the hazard, and impact which indicates physical, social, system, and functional effects or actions caused by the exposure.

According to the embodiments of the present disclosure described above, by visualizing the situation and flow of damage caused by a disaster in the form of a scenario through a symbolization model that defines the history of disaster damage as a standardized component, it is possible to present various scenarios regarding the disaster damage progression pattern by reusing knowledge regarding the history and experience of disasters, and through a unified method of expressing disaster damage scenarios, consistent expression and common understanding of disaster situations are possible, and easy establishment of response strategies based on disaster damage scenarios can be induced.

### BRIEF DESCRIPTION OF THE DRAWING

FIG. 1 is a diagram exemplifying a white paper and accident investigation report on a conventional disaster.

FIG. 2 is a diagram illustrating a process of generating a structured disaster damage scenario from disaster damage histories and utilizing the structured disaster damage scenario according to embodiments of the present disclosure.

FIG. 3 is a flowchart illustrating a method for structuring disaster information according to one embodiment of the present disclosure.

FIG. 4 is a diagram illustrating components of a disaster defined in a symbolization model for symbolizing a disaster damage progression pattern of embodiments of the present disclosure.

FIG. 5 is a diagram illustrating a frame configuration for generating a chain damage flow of a disaster according to one embodiment of the present disclosure.

FIG. 6 is a flowchart additionally illustrating a process of providing additional information composition and response strategies in the method for structuring disaster information of FIG. 3.

FIG. 7 illustrates an example of expressing a change in a state of a damage object caused by heavy rain using a symbolization model proposed by embodiments of the present disclosure.

FIG. 8 illustrates an example of expressing a chain damage scenario of a disaster caused by a typhoon using a symbolization model proposed by embodiments of the present disclosure.

FIG. 9 is a block diagram illustrating a disaster information management device that structures disaster information according to one embodiment of the present disclosure.

### DETAILED DESCRIPTION

Hereinafter, embodiments of the present disclosure will be specifically described with reference to the drawings. However, detailed descriptions of well-known functions or configurations that may obscure the gist of the embodiments in the following description and the attached drawings will be omitted. In addition, throughout the specification, the term “including” a component does not exclude other components unless specifically stated to the contrary, but rather means that other components may be included.

The terminology used herein is for the purpose of describing particular embodiments only and is not intended to be limiting of the present disclosure. The singular expression includes the plural expression unless the context clearly indicates otherwise. In this application, it should be understood that the terms “include” or “have” and the like are intended to specify the presence of a described feature, number, step, operation, component, part, or combination thereof, but do not exclude in advance the possibility of the presence or addition of one or more other features, numbers, steps, operations, components, parts, or combinations thereof.

Unless specifically defined otherwise, all terms used herein, including technical or scientific terms, have the same meaning as commonly understood by one of ordinary skill in the art to which the present disclosure belongs. Terms defined in commonly used dictionaries, such as those defined in common usage, should be interpreted as having a meaning consistent with the meaning they have in the context of the relevant art, and shall not be interpreted in an idealized or overly formal sense unless explicitly defined herein.

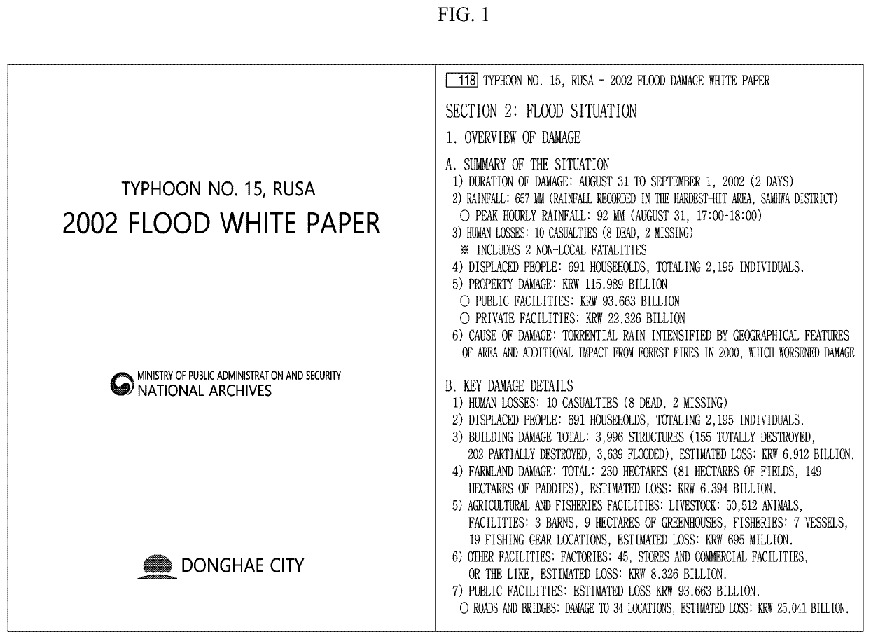

FIG. 1 is a diagram illustrating an example of a white paper and accident investigation report on a conventional disaster, illustrating a flood white paper on Typhoon “RUSA” that caused great damage to South Korea in 2002. This document contains a lot of information on the flood situation and damage, and is helpful in understanding the progression pattern of the typhoon damage. However, since it is a report written mainly based on specific records, the white paper in FIG. 1 has difficulty in conveying information on the typhoon damage in a concise and intuitive manner.

Governments and disaster-related organizations generally publish documents in the form of narrative or tabular formats to describe the situations of disaster occurrence and the damage that may occur due to the disaster. For example, disaster history and experience are recorded in the form of documents or reports such as white papers and accident investigation reports. When recorded, stored, and managed in the form of documents such as white papers or reports, it is helpful in understanding the detailed history of the case, but it is difficult to reuse knowledge about the damage history and experience of disasters.

FIG. 2 is a diagram illustrating a process of generating a structured disaster damage scenario from disaster damage histories and utilizing the structured disaster damage scenario according to embodiments of the present disclosure.

Due to the nature of the work that requires a short-term understanding of various situations, conditions, and possibilities, such as disasters, and the preparation of response measures, it is necessary to be able to intuitively determine detailed information about the disaster situation, the detailed flow of various damages that may occur due to the disaster, and the work to respond to the damage in a short period of time. In particular, it is important to analyze the potential risks and complex chain of damage patterns that can progress to what extreme situations can occur when the disaster expands over time, rather than simply listing the subsequent damages that lead to the disaster. To this end, a new system is needed that increases readability by writing the flow, characteristics, and causal factors of the social and physical phenomenon called disaster in a diagrammatic (symbolic) form rather than a descriptive form, and allows users to easily and uniquely create and reuse it.

Referring to FIG. 2, various documents 210 (white paper, report, casebook, or the like) related to disaster damage are created, and these documents are collected into a database 230. Conventional disaster analysis or disaster management organizations have produced documents related to disaster damage and reviewed the produced documents in this way, but it has been pointed out as a weakness that it is difficult to convey the contents to outside the organization or to a new person in charge. In addition, when trying to simulate a disaster damage situation from numerous records or create a new disaster damage scenario, there is a lack of sophisticated technical means for expressing the disaster situation. For example, when a person in charge who is familiar with conventional disaster damage-related documents creates a new disaster damage scenario, it may be difficult for other people in charge to understand it, or when multiple people in charge define or describe the disaster situation in different ways, it may rather increase confusion. As a result, there is a concern that when a disaster damage scenario is created in an unclear manner, a disaster response strategy or plan for the damage scenario may also be established inappropriately.

Therefore, the embodiments of the present disclosure presented below propose a method for multiple users to jointly create the progression pattern and impact of a disaster accident that may occur when a single hazard is exposed to various facilities in our society in a digitalized form and symbol. That is, a technical means for creating a structured disaster damage scenario 250 from the database 230 that collects the various disaster-related documents 210 is proposed. This structured disaster damage scenario 250 enables multiple people in charge to define or express the disaster situation in a unified manner through a predefined symbolization model, and enables the creation of a scenario that conforms to a logical causal relationship by expressing detailed items appropriate for each stage for individual phenomena within a time-series progression pattern. As a result, when the structured disaster damage scenario 250 is created, it becomes easy to establish a disaster response strategy or plan 270 for the damage scenario.

Below, a modeling method and main components thereof for generating the structured disaster damage scenarios are proposed.

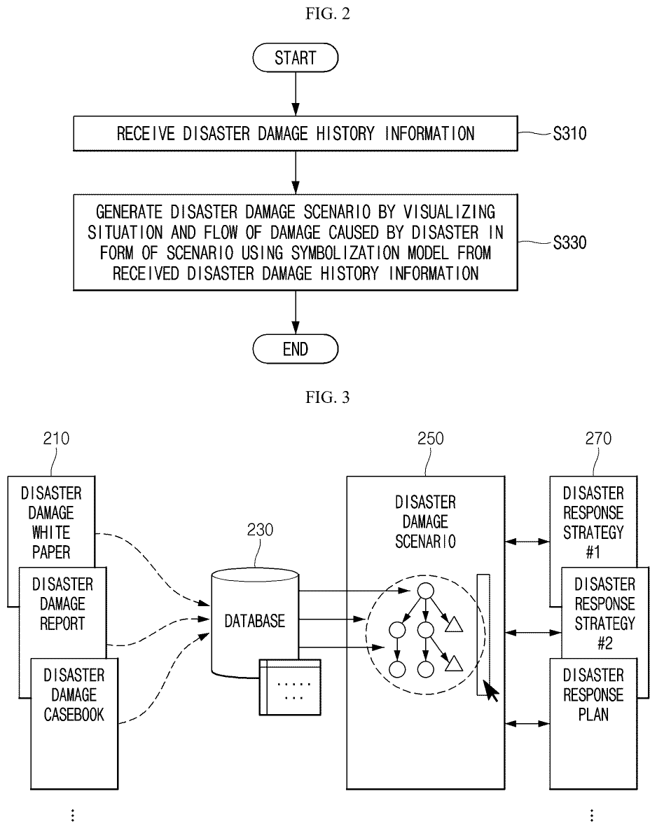

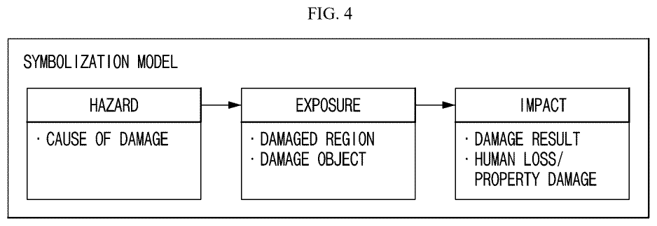

FIG. 3 is a flowchart illustrating a method for structuring disaster information according to one embodiment of the present disclosure, which may be performed by a disaster information management device including at least one processor.

In Step S310, the disaster information management device receives the disaster damage history information. The disaster damage history information may be in various forms of documents such as a conventional disaster damage white paper, report, or casebook, and may be received in an electronic format for data processing.

In Step S330, the disaster information management device generates a disaster damage scenario by visualizing the situation and flow of damage caused by the disaster in the form of a scenario using a symbolization model from the disaster damage history information received through Step S310. Here, the symbolization model should express the chain damage flow of the disaster as a unique symbol according to the disaster damage progression pattern, but should be expressed as a predefined component. The symbolization model proposed by the embodiments of the present disclosure consists of at least the following three components.

First, hazard is a component that represents natural phenomena or human-induced physical events or physical influences that cause damage.

Second, exposure is a component that indicates that an entity such as a human, living organism, ecosystem, building, and facility is in contact with the hazard.

Third, impact is a component that indicates the physical, social, system, and functional effects or actions caused by the exposure.

In other words, the above symbolization model includes components classified into hazard, exposures, and influences, and is structured to express the time-series causal relationship of previously input disaster damage history information according to the above definition. The symbolization model was proposed as a symbolic method for objectively expressing the disaster or disaster progression pattern itself regardless of the person in charge. Therefore, after one component is set at the current stage, other components that may appear at the next stage should be presented according to logical correlations with each other.

To this end, in the symbolization model, the hazard, the exposure, and the impact should be set in advance as unique symbols according to the types of detailed components, and the items that can occur should be linked and configured according to the time-series order or causal relationship of each component. In addition, it is preferable that the unique symbols be set so that the unique symbols can be visually identified through at least one of the shape or color of the figure, or a combination thereof. The symbolization model generated through such a diagrammatic and visualization process can intuitively provide relatively objective and clear information to a large number of people with different levels of understanding of disaster cases.

FIG. 4 is a diagram illustrating components of a disaster defined in a symbolization model for symbolizing the disaster damage progression pattern of embodiments of the present disclosure.

Previously, we explained that we proposed a symbolization model as a new system that increases readability and allows users to easily and uniquely create and reuse the progressive flow, characteristics, and causal factors of the social and physical phenomenon called the disaster by preparing them in a diagrammatic rather than descriptive form.

Accordingly, the embodiments of the present disclosure suggest a method of creating, storing, and sharing with others the situations and flows of various damages that may occur when entities such as humans, living organisms, ecosystems, buildings, and facilities are exposed to hazards and receive physical, social, system, and functional impacts due to natural phenomenon or human-induced physical events or physical impacts (hazards) in a diagrammatic form. In order to create the situation and flow of damage caused by the disaster in a diagrammatic form, the embodiments of the present disclosure propose a shape (model, frame) that creates the chain damage flow based on the model of hazards, exposure, and impact of risk assessment.

Referring to FIG. 4, the symbolization model has three components such as the hazard, exposure, and impact, and each component again contains detail components.

First, in the symbolization model, the hazard may have, as the detailed components, damage causes that are set according to at least one of the conditions of the type, scale, and region of the disaster. Therefore, when creating the disaster damage scenario, when multiple causes causing damage have a sequential structure, the order of the causes may be visually displayed differently.

Second, in the symbolization model, the exposure may have, as the detailed components, a damaged region that represents geographical information where damage occurs and a damage object that represents an object where the damage occurs in a region in contact with the hazard. Therefore, when creating the disaster damage scenario, the geographical type or administrative district of the damaged region is set, and according to the setting of the damaged region, a physical natural object or artificial object within the region may be set as the damage object.

Third, in the symbolization model, the impact may have, as the detailed components, a damage result that represents the change in the state of the damage object due to the cause of damage and human losses and property damage that occurs in the damage object according to the damage result. Therefore, when creating a disaster damage scenario, the state in which the target's intended function is completely lost or the state in which the physical form or nature of the target is changed may be set as the damage result, and the type of damage that occurs according to the setting of the damage result may be set according to the classification criteria.

The three components may be displayed through a symbolization model authoring tool according to the time-series order and causal relationship. The symbolization model authoring tool may display each object on a display device and have a user interface (UI) for manipulating the object, and may display objects (components) that match the causal relationship before and after each item according to the structure of the symbolization model defined above on the screen. For example, when the damaged region, which is the detailed component, is set in the exposure of the symbolization model, candidate objects regarding the impact corresponding to the corresponding damaged region may be presented as additional information based on the accumulated disaster damage history information. More specifically, the damage results, human losses/property damage, and the like for the corresponding damaged region may be presented as selectable candidate objects, and the next stage disaster development scenario is generated according to the automated candidate generation algorithm or the selection of the manager.

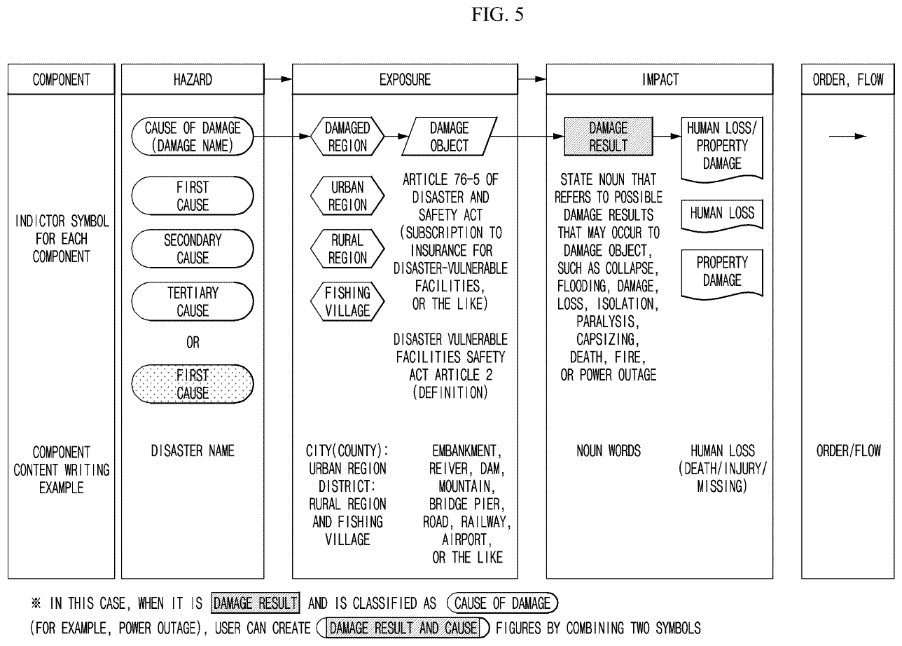

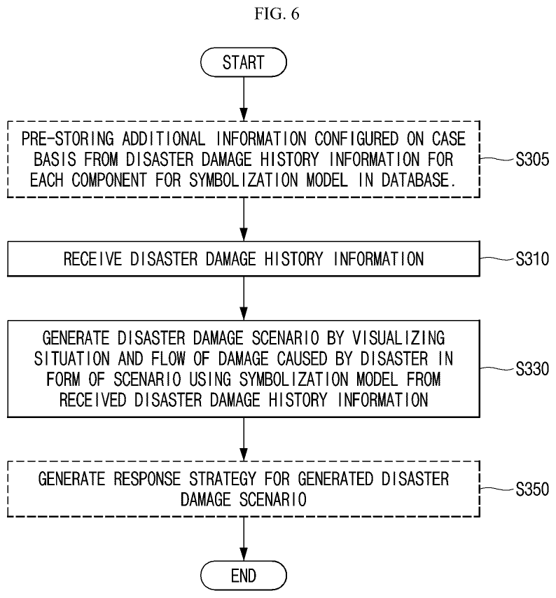

FIG. 5 is a diagram illustrating a frame configuration for generating the disaster chain damage flow according to one embodiment of the present disclosure. Hereinafter, a disaster damage scenario created according to a symbolization model may express an object according to a description of a symbol representing a damage flow as illustrated in Table 1 below.

TABLE 1

| Classification | Definition and writing examples |
|---|---|
| Definition | Symbol is arrow symbol that indicates order and flow of disaster |
| | damage progression |
| Arrow color | User can distinguish and express using black, red, blue, or the like |
| Arrow type | Solid line: Damage flow with past history |
| | Dotted line: damage flow created by user but no history has yet |
| | occurred |
| Arrow thickness | Thickness can be expressed as thin, medium, or thick to indicate |
| | possibility of damage occurring |
| Arrow content | As explanation of situation when damage progresses, for example, in |
| | case of Great East Japan Earthquake, height was 10 m and run-up |
| | height was 40.1 m. |

In addition, FIG. 6 is a flowchart additionally illustrating a process of providing additional information composition and response strategies in the method for structuring disaster information of FIG. 3. Referring to FIG. 6, the method for structing disaster information may further include a step (Step S305) of pre-storing additional information configured on a case basis from the disaster damage history information for each component for the symbolization model in a database. This additional information may be stored by linking items that may occur according to the time-series order or causal relationship of each of the detailed components of the hazard, the exposure, and the impact that configure the symbolization model.

Again, referring to FIG. 5, the process of deriving detailed components using additional information is explained. The disaster damage flow model covered in the present disclosure starts with a natural phenomenon or human-induced physical event or physical influence (hazard) that causes damage. At this time, the damage cause may be freely set or input according to the conditions of the type, scale, region, or the like of the disaster created by the user. For example, a figure is drawn as an oval, and the order of the damage-causing causes may be expressed differently by changing the fill color of the oval. At this time, detailed information on the damage cause input in the oval symbol may be input into the database as additional information on the cause of the damage, as illustrated in Table 2 below.

TABLE 2

| Classification | Definition and writing examples |
|---|---|
| Name | Definition: Describe disaster name that initiates disaster damage |
| | scenario |
| | Example: typhoon, earthquake, heat wave, power outage, fire, or the |
| | like |
| Emergency | Definition: emergency situation classification for disaster set in |
| situation | scenario production |
| classification | Examples: Results-oriented, slow-moving, and instantaneous |
| | amplification |
| Disaster | Definition: classification of disaster set in scenario production |
| classification | Examples: natural disaster, social disaster |
| Disaster damage | Definition: damage scale of disaster set in scenario production |
| scale | Examples: metropolitan, regional, facility |
| Description | Definition: Describe definition and description of disaster name |
| | Example: localized weather phenomenon in which tropical cyclone |
| | that originated in tropical sea develops and is accompanied by strong |
| | storms with maximum wind speeds of 17.2 m/s or more near the |
| | center |
| Case | Definition: name of past disaster case referenced in writing of this |
| | damage scenario |
| | Examples: Typhoon RUSA in 2002, Typhoon MAEMI in 2003 |
| Source | Definition: List of references used in writing damage scenarios. |
| | Example: flood damage white paper prepared by Gangneung City |
| Crisis alert criteria | Definition: describe criteria for determining typhoon crisis alerts |
| | Example: |
| | (Interest) Typhoon season, timing of typhoons and heavy rains that |
| | may affect our country |
| | (Caution) When typhoon preliminary warning is issued and there is |
| | possibility of large-scale disaster due to typhoon, (omitted) |
| | (Warning) When typhoon warning is issued and there is high |
| | possibility of large-scale disaster due to typhoon, (omitted) |
| | (Serious) When typhoon alert is issued and large-scale disaster |
| | caused by typhoon has occurred or is likely to occur, (omitted) |
| Responsible | Definition: responsible department in charge of disaster |
| department: | Examples: Ministry of Public Administration and Security, Ministry |
| | of Land, Infrastructure and Transport, Disease Control and |
| | Prevention Agency, or the like |
| User Addition | Definition: information that can be defined and input by user when |
| (Rainfall) + @ | creating disaster damage scenario. |
| ★(weather | Example: Rainfall centered in Gangneung region, maximum 24-hour |
| condition, | rainfall of 944.5 mm, maximum 1-hour rainfall of 113.5 mm |
| condition of | |
| situation) | |

Referring to Table 2, additional information on the cause of damage, including at least one of the emergency situation classification, the disaster classification, disaster damage scale, the case, the crisis warning criteria, and responsible department, can be stored in the database. Accordingly, when generating the disaster damage scenario, the detailed components of the hazard may be displayed through a user interface (UI) by referring to the additional information on the cause of damage called from the database. For example, when the cause of damage is a typhoon, it can be known that the disaster is a natural disaster, and the reference cases may be Typhoon RUSA in 2002 or Typhoon MAEMI in 2003. These cases were collected through the Flood Damage White Paper prepared by Gangneung City, and guidance is provided so that more specific sources can be confirmed when necessary. In addition, for example, in the case of a typhoon, by storing the crisis warning criteria and responsible department together, it is possible to induce the establishment of a response strategy by the responsible department according to the crisis level of each scenario.

After the cause of damage is input, information on the region where damage occurs due to exposure to the hazard may be input into the hexagonal shape, with administrative district names categorized as urban regions, rural regions, and fishing villages. At this time, the administrative district of city/county/district means the urban regions, and the administrative district of county means the rural regions or fishing villages. Additional detailed information on the damaged region is stored in the database as illustrated in Table 3.

TABLE 3

| Classification | Definition and writing examples |
|---|---|
| Name | Definition: describe name of city/county/district where disaster |
| ★(Region of | damage occurs |
| Interest) | Examples: Gangneung-si, Gangwon-do, Seoul, nationwide, or the |
| | like |
| Description | Definition: describe or color-code topographical and special features |
| | of a city, county, or district region that can be used as reference for |
| | creating disaster damage scenarios |
| | Examples: urban region, rural region, coastal region, forest region |
| User Addition | Definition: information that users can define and input when creating |
| (Special Note) + @ | disaster damage scenario |
| ★(Geographic | Examples: densely populated region, lowland, or the like |
| characteristics) | |

Referring to Table 3, by specifying the topographical features of each preset region, it is possible to help a person in charge who lack understanding of the region easily identify the expected disaster-related geographical features in the disaster damage scenario. For example, Gangneung-si, Gangwon-do is a coastal region, but the region heading toward Daegwallyeong is a forest region, so when a more specific administrative district is specified, the exact geographical features of the region can be specified. For example, in Gangneung-si, Gangwon-do, when a forest fire occurs, the regions that can directly cause damage can be divided, and by referring to detailed additional information such as Table 3, it is possible to accurately predict whether the region will be damaged by the previously selected cause of damage. As a more specific example, Seongsan-myeon, Gangneung-si, Gangwon-do is a forest region that is directly affected by forest fires, whereas Gangmun-dong, Gangneung-si, Gangwon-do is an urban or coastal region that is not directly affected by forest fires.

Next, after the region exposed to the hazard is set, information on the target where the damage occurs can be input to the target where the damage occurs in a damage flow diagram using a parallelogram figure. At this time, the target where disaster damage occurs or may occur refers to physical natural and artificial objects such as facilities and buildings such as mountains, roads, houses, apartments, public facilities, rivers, reservoirs, or the like. These damage objects provide infrastructure and services in our society such as medical care, finance, and education, and the damage objects are important elements of the disaster flow in understanding the chain of damage from disasters and extreme situations that can occur due to hazard. The detailed additional information on the damage objects is stored in the database as illustrated in Table 4.

TABLE 4

| Classification | Definition and writing examples |
|---|---|
| Name | Definition: name of object where disaster damage occurs or may |
| | occur |
| | Examples: mountain, road, house, apartment, public facility, river, |
| | reservoir, or the like |
| Classification | Definition: classification type for distinguishing object |
| | Examples: building, facility, natural object, or the like |
| | ※ For consistency, systematic classification system and list by |
| | classification type are required |
| Function | Definition: Social and environmental function provided by object |
| classification | Example: Need for linkage with disaster response work under |
| ★(Service | administrative departments such as housing, education, |
| interruption) | communications, energy, transportation, leisure, tourism, water |
| | management, and health care |
| Description | Definition: dictionary social definition of what name of object means |
| | Example: type of housing where, as one type of apartment complex, |
| | building of five or more floors is divided into several houses on each |
| | floor, allowing each household to live independently |
| User Addition | Definition: geographical characteristics or vulnerabilities, risks, or |
| (Geographic | the like where object is located |
| characteristics) + @ | Example: large-scale accident may occur in event of fire or collapse |
| | in multi-dense facility |

First, when the damaged region is selected, the specific types of objects where the disaster damage occurs or may occur within the region need to be presented. The damage objects that can be presented may vary depending on the damaged region. For example, when Seongsan-myeon, Gangneung-si, Gangwon-do, which is a forest region, is selected as the damaged region, the damage object may be a mountain, and accordingly, it can be specified that mountains which are natural objects or mountain roads or power lines which are the facilities may be damaged. In the case of roads, it may be expected that the provision of transportation functions will be interrupted, and in the case of power lines, it may be expected that the power supply will be interrupted. Therefore, by referring to the detailed additional information in Table 4, it is possible to specify the specific damage objects expected in the damaged region.

Referring to Table 3 and Table 4, the additional information on the damaged region including at least one of the region name, the region type, and the topographical feature, and additional information on the damage object including at least one of the classification type indicating a target where damage occurs or may occur, and the functional classification indicating a social and environmental function provided by the target can be stored in a database. Accordingly, in generating of the disaster damage scenario, the detailed components of the exposure may be displayed through the user interface by referring to the additional information on the damaged region and the additional information on the damage object called from the database.

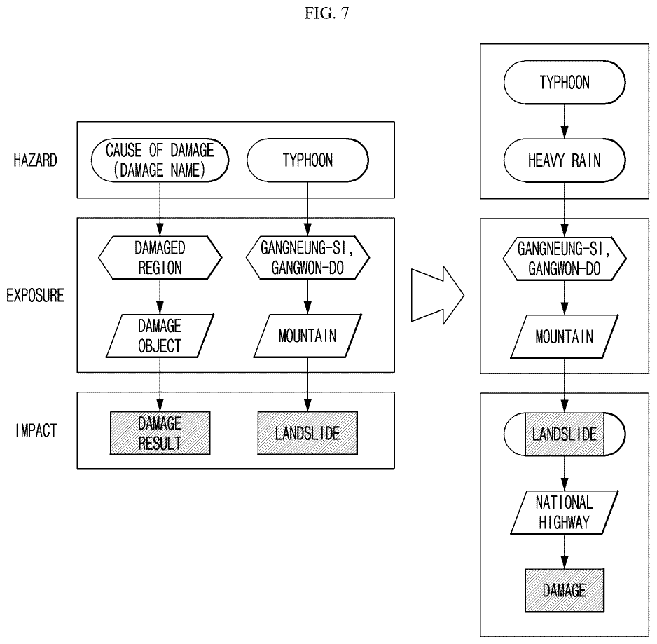

Now, in the damage object located inside the damaged region, the state of the damage object changes due to the physical and social external force of the hazard. In the present disclosure, the state change of the damage object due to the cause of the damage is defined as the damage result and may be expressed as a rectangular figure. For example, a disaster flow in which Gangneung-si, Gangwon-do (damaged region) is exposed to a typhoon (hazard) accompanied by heavy rain and a landslide (impact) occurs on a mountain (damage object) may be expressed as in FIG. 7. FIG. 7 illustrates an example of expressing the change in the state of the damage object caused by heavy rain using the symbolization model proposed by embodiments of the present disclosure.

The impact of the change in the state of the target due to the hazard means the state in which the target's intended function is completely lost or the state in which the physical form or nature of the target is changed. At this time, the state of the target can be expressed by a term (for example, a landslide) indicating a social disaster or a natural disaster. The status of the target (result/impact due to hazard) is created by repeating the process described above, starting with the cause of damage and re-creating the disaster damage flow diagram as the hazard. Additional detailed information on the impact may be stored in the database as in Table 5.

TABLE 5

| Classification | Definition and writing examples |
|---|---|
| Name | Definition: word meaning change in properties of physical form of |
| ★ | object. |
| (Incident/secondary | Examples: collapse, shaking, damage, loss, overturning, burial, |
| risk) | flooding, fire |
| | ※Since same meaning can be expressed by different words, list is |
| | needed to maintain consistency |
| Description | Definition: descriptive sentence of word that indicate change in state |
| | of target |
| | Example |
| | Collapse: falling apart and breaking apart |
| | Shaking: constant movement up and down, left and right, or back |
| | and forth |
| | Paralysis: dulling or stopping of original functions |
| User Addition | Definition: past case and source where event occurred that changed |
| (Reference) + @ | physical form of past object |
| | Example: page 172, flood damage white paper, Gangneung City, |
| | Typhoon RUSA, 2002 |

Meanwhile, due to the cause of the damage, the state of the damage object in the damaged region changes, the object loses the intended function thereof, and social functional damage, human losses, or property damage occurs. In the embodiments of the present disclosure, this is divided into human losses and the property damage, and the disaster damage flow diagram is created using a rectangle ( [symbol] ) whose lower side is wavy. In this case, the fill color of the figure is red in the human losses, the fill color of the figure is turquoise in the property damage, so that human losses and property damage are expressed differently, thereby improving readability. The detailed additional information on the human losses, the property damage to property may be stored in the database as the contents of Tables 6 and 7, respectively.

TABLE 6

| Classification | Definition and writing examples |
|---|---|
| Name | Definition: describes type of human losses |
| ★(Human losses, | Examples: human losses, isolation, human losses (death), death by |
| long-term health) | falling, or the like |
| Case | Definition: case in which human losses have occurred in past |
| | Examples: Typhoon RUSA in 2002, Typhoon MAEMI in 2003 |
| User Addition | Definition: degree and scale of human losses |
| (Damage scale) + @ | Example: 51 dead, 10 injured, 13 missing, or the like |

TABLE 7

| Classification | Definition and writing examples |
|---|---|
| Name | Definition: Describes type of property damage |
| ★(Property | Examples: property damage, fisheries damage, economic damage |
| damage, economic | |
| impact) | |
| Case | Definition: case in which property damage has occurred in past |
| | Examples: Typhoon RUSA in 2002, Typhoon MAEMI in 2003 |
| User Addition | Definition: degree and scale of property damage |
| (Damage scale) + @ | Example: 100 houses damaged, 1 billion won, or the like |

Referring to Table 5, Table 6, and Table 7, the additional information on the impact including the type of change in the state of the target and the additional information on the human losses and property damage including the type of damage may be stored in the database. Accordingly, when generating a disaster damage scenario, the detailed components of the impact may be displayed through the user interface by referring to the additional information on the impact and the additional information on human losses and property damage called from the database. Through this, the information on exposure determined in the previous step, more specifically, the impact on the region and target can be identified by specifying the damaged region and damage object. For example, when Seongsan-myeon, Gangneung-si, Gangwon-do, which is a forest region, is specified, a landslide may be predicted as the damage result, and in the case where the damage object is the building such as house, human losses and property damage may occur, and it is possible to predict the degree and scale of the damages thereof. As described above, it is possible to create probable disaster damage scenarios through the symbolization model, and these scenarios may be designed through modeling based on the time-series causal relationships likely to occur for each component from the existing disaster history information.

Referring again to FIG. 6, the method for structuring disaster information may further include a step (Step S350) of generating a response strategy for the disaster damage scenario generated through Step S330. Here, in the response strategy, it is preferable that the disaster damage situations are derived according to the disaster damage scenario, response agencies are set for each detailed item in response to each derived disaster damage situation, and response tasks are assigned to each of the set response agencies according to the passage of time.

To this end, the additional information that is constructed based on the case from the disaster damage history information may be utilized for each component for the symbolization model. For example, referring to Table 2, which illustrates the configuration of an additional information database for the cause of damage, since the responsible department for the disaster is specified, the response agency in charge of each component of the disaster damage scenario illustrated in the chain damage flow of the disaster may be automatically set. In addition, the response tasks that the corresponding response agency should perform may be assigned in time series through the detailed component defined according to the symbolization model of the disaster damage scenario.

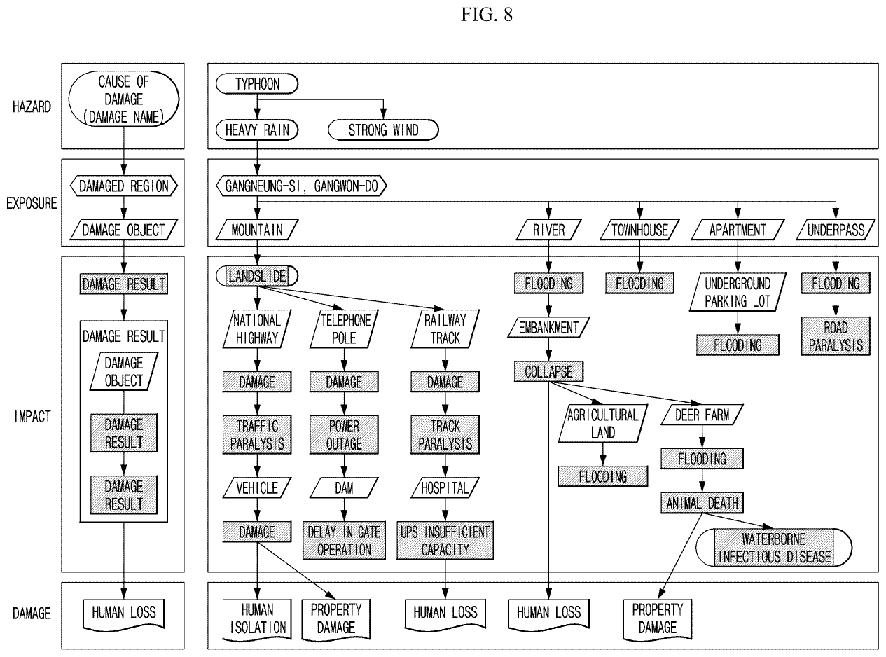

FIG. 8 illustrates an example of expressing a chain damage scenario of a disaster caused by a typhoon using a symbolization model proposed by embodiments of the present disclosure. Referring to FIG. 8, the progression pattern of the disaster is expressed in the order of the hazard, exposure, and impact according to the symbolization model described above, and the detailed components constituting each component are also symbolized according to the defined method. As a result, various disaster situation candidates are generated to present scenarios of various disaster progression patterns, and finally, the expected human losses and property damage can be derived. These disaster damage scenarios are not arbitrarily composed by the person in charge, but are derived from a symbolization model derived as a result of observing the elements of the existing disaster damage history information separately. In particular, since the symbolization model itself is designed based on a logical causal relationship, it is possible to present the next disaster pattern that can occur from one disaster pattern, and include all disaster occurrence possibilities that an inexperienced person in charge may miss as candidates.

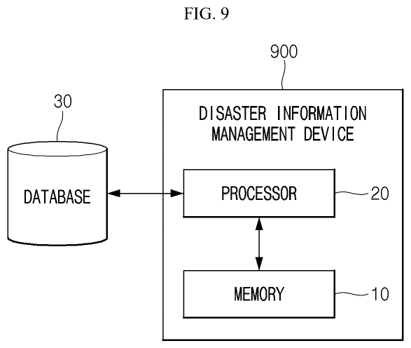

FIG. 9 is a block diagram illustrating a disaster information management device 900 that structures the disaster information according to one embodiment of the present disclosure, and includes a memory 10 that stores a program that receives the disaster damage history information and structures the disaster information, and a processor 20 that executes the program stored in the memory. Here, the program includes a command that generates the disaster damage scenario by visualizing the situation and flow of the damage caused by the disaster in the form of a scenario using the symbolization model from the input disaster damage history information. In particular, the symbolization model represents the chain damage flow of the disaster with the unique symbol according to the disaster damage progression pattern, and includes components classified into hazard that represents a natural phenomenon, a human-induced physical event, or physical impact caused by a human being that causes the damage, exposure that represents an entity such as a human, a living organism, an ecosystem, a building, or a facility being into contact with the hazard, and impact that represents a physical, social, system, and functional effect or action caused by the exposure.

In the disaster information management device structuring the disaster information according to one embodiment, in the symbolization model, the hazard, the exposure, and the impact may be set in advance as unique symbols according to the type of the detailed component, and items that can occur may be linked and configured according to a time-series order or causal relationship of each component, and the unique symbol may be set so that the unique symbol is visually identified through at least one of a shape or color of a figure or a combination thereof.

In addition, the disaster information management device structuring the disaster information according to one embodiment may further include a database 30 that stores the additional information configured on the case basis from the disaster damage history information for each component for the symbolization model in advance. The additional information may be stored in linked with items that may occur according to the time-series order or causal relationship of each of the detailed components of the hazard, exposure, and impact that constitute the symbolization model.

In addition, the disaster information management device that structures the disaster information according to one embodiment may further perform a command to generate the response strategy for the generated disaster damage scenario. The response strategy may derive a disaster damage situation according to the disaster damage scenario, set the response agency for each detailed item in response to each derived disaster damage situation, and assign a response task according to the passage of time to each of the set response agencies.

Embodiments according to the present disclosure may be implemented by various means, for example, hardware, firmware, software, or a combination thereof. In case of implementation by hardware, one embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like. In case of implementation by firmware or software, one embodiment of the present disclosure may be implemented in the form of a module, procedure, function, and the like that performs the capabilities or operations described above. Software codes may be stored in a memory and executed by a processor. The memory may be located inside or outside the processor, and may exchange data with the processor by various means already known.

Meanwhile, the embodiments of the present disclosure can be implemented as computer-readable codes on a computer-readable recording medium. The computer-readable recording medium includes all kinds of recording devices that store data that can be read by a computer system. Examples of the computer-readable recording medium include ROMs, RAMs, CD-ROMs, magnetic tapes, floppy disks, optical data storage devices, or the like. In addition, the computer-readable recording medium may be distributed over network-connected computer systems, so that the computer-readable codes can be stored and executed in a distributed manner. In addition, functional programs, codes, and code segments for implementing the embodiments can be easily inferred by programmers in the technical field to which the present disclosure belongs.

According to the embodiments of the present disclosure described above, by visualizing the situation and flow of damage caused by the disaster in the form of the scenario through the symbolization model that defines the disaster damage history as a standardized component, it is possible to present various scenarios regarding the disaster damage progression pattern by reusing knowledge regarding the history and experience of disasters, and through a unified method of expressing disaster damage scenarios, consistent expression and common understanding of disaster situations are possible, and easy establishment of response strategies based on the disaster damage scenarios can be induced.

In the above, the present disclosure has been examined with a focus on various embodiments thereof. Those skilled in the art to which the present disclosure pertains will understand that various embodiments can be implemented in modified forms without departing from the essential characteristics of the present disclosure. Therefore, the disclosed embodiments should be considered from an illustrative rather than a restrictive perspective. The scope of the present disclosure is indicated by the claims, not the foregoing description, and all differences within the equivalent scope should be interpreted as being included in the present disclosure.

1. A method for structuring disaster information by a disaster information management device including at least one processor, the method comprising:
receiving disaster damage history information by the disaster information management device; and
generating a disaster damage scenario by visualizing a situation and flow of damage caused by a disaster in the form of a scenario using a symbolization model from the received disaster damage history information by the disaster information management device,
wherein the symbolization model represents a chain damage flow of the disaster with a unique symbol according to a disaster damage progression pattern, and
includes components classified into
hazard which indicates a natural phenomenon or human-induced physical event or physical influence that causes the damage,
exposure which indicates that an entity such as a human, living organism, ecosystem, building, or facility is into contact with the hazard, and
impact which indicates physical, social, system, and functional effects or actions caused by the exposure.

2. The method of claim 1, wherein in the symbolization model, the hazard, the exposure, and the impact are set in advance as unique symbols according to a type of a detailed component, and items that can occur are linked and configured according to a time-series order or causal relationship of each component, and
the unique symbol is set so that the unique symbol is visually identified through at least one of a shape or color of a figure or a combination thereof.

3. The method of claim 1, wherein in the symbolization model, the hazard has, as a detailed component, a cause of damage set according to at least one of the conditions of a type, scale, and region of the disaster, and
in the generating of the disaster damage scenario, when a plurality of causes causing the damage have a sequential structure, the order of the causes is visually displayed differently.

4. The method of claim 1, wherein in the symbolization model, the exposure has, as a detailed component, a damaged region indicating geographical information where damage occurs and a damage object indicating an object where damage occurs in a region in into contact with a hazard, and
in the generating of the disaster damage scenario,
a geographical type or administrative district of the damaged region is set, and
according to the setting of the damaged region, a physical natural object or artificial object within the region is set as the damage object.

5. The method of claim 1, wherein in the symbolization model, the impact has, as a detailed component, a damage result indicating a change in a state of a damage object due to the cause of the damage, and human losses and property damage occurring in the damage object according to the damage result, and
in the generating of the disaster damage scenario,
a state in which a target's intended function is completely lost or a physical form or properties of the target are changed is set as the damage result, and
the type of damage that occurs according to the setting of the damage result is set according to the classification criteria.

6. The method of claim 1, further comprising pre-storing additional information organized based on cases from the disaster damage history information for each component for the symbolization model in a database,
wherein the additional information is stored in a manner that links possible occurrence items according to a time-series order or causal relationship of each of the detailed components of the hazard, the exposure, and the impact that constitutes the symbolization model.

7. The method of claim 6, wherein in the pre-storing of the additional information in the database, additional information on the cause of damage including at least one of emergency situation classification, disaster classification, a disaster damage scale, a case, crisis warning criteria, and a responsible department is stored in the database, and
in the generating the disaster damage scenario, the detailed components of the hazard are displayed through a user interface (UI) by referring to the additional information on the cause of damage called from the database.

8. The method of claim 6, wherein in the pre-storing of the additional information in the database, additional information on the damaged region including at least one of a region name, a region type, and a topographical feature, and additional information on a damage object including at least one of a distinction indicating a classification type indicating a target where damage has occurred or may occur and a functional classification indicating a social and environmental function provided by the target are stored in the database, and
in the generating of the disaster damage scenario, the detailed components of the exposure are displayed through a user interface by referring to the additional information on the damaged region and the additional information on the damage object called from the database.

9. The method of claim 6, in the pre-storing of the additional information in the database, additional information on impact including the type of change in the state of the target and additional information on human losses and property damage including the type of damage are stored in the database, and
in the generating of the disaster damage scenario, the detailed component of the impact is displayed through a user interface by referring to the additional information on impact and the additional information on the human losses and property damage called from the database.

10. The method of claim 1, further comprising generating a response strategy for the generated disaster damage scenario,
wherein in the response strategy,
a disaster damage situation is derived according to the disaster damage scenario, a response agency for each detailed item is set in response to each derived disaster damage situation, and a response task is assigned according to passage of time to the set response agency.
